(19) United States
(12) Patent Application Publication
(10) Pub. No.: US 2016/0371174 A1
(43) Pub. Date: Dec. 22, 2016

(54) STATIC TEST SUPPORTING SYSTEM

(71) Applicant: Hitachi Systems, Ltd., Shinagawa-ku, Tokyo (JP)

(72) Inventor: Hideki Ikeda, Shinagawa-ku, Tokyo (JP)

(21) Appl. No.: 14/781,128

(22) PCT Filed: Jul. 3, 2014
(86) PCT No.: PCT/JP2014/067835

§ 371 Date: Sep. 29, 2015

(51) Int. Cl. G06F 11/36

(52) U.S. Cl. CPC G06F 11/3668

(57) ABSTRACT

A static test supporting system capable of recording an evidence of actual visual check of a source code by a reviewer in a static test in social coding and of accumulating and displaying information on a result of execution of the static test. According to a typical embodiment, a development managing server has a review controlling unit for recording execution information of the static test acquired from a reviewer terminal on a review-status recording unit, and the reviewer terminal has a viewpoint monitoring unit for acquiring information on a viewpoint of the reviewer by using an eye camera. When the reviewer executes the static test for the source code, information on the viewpoint acquired by the viewpoint monitoring unit is tracked, it is regarded that a row corresponding to a route of the viewpoint in the source code has been visually checked, and that the check for the row has been executed when a predetermined proportion of the row or higher has been visually checked, and execution information on the static test is transmitted to the development managing server.

### CROSS REFERENCE TO RELATED APPLICATIONS

This application is entitled to the benefit of and incorporates by reference subject matter disclosed in International Patent Application No. PCT/JP2014/067835 filed on Jul. 3, 2014.

### TECHNICAL FIELD

The present invention relates to a technique of software development, and, more particularly, the present invention relates to a technique effectively applied to a static test supporting system for supporting execution of a static test of source code review, etc.

### BACKGROUND ART

In software development, generally, a static test without executing a program is performed before a dynamic test with practically executing a developed program for test. As the static test, several tests which are different from each other in a method, a purpose, etc., such as source code review, an inspection, and peer review, are known.

As the technique about the static test of the program, for example, Japanese Patent Application Laid-Open Publication No. H09-26897 describes a program analyzing device including: data extracting means for extracting, from a source code, data information which is the information indicating a structure of each piece of data contained in the source code; association extracting means for extracting association information indicating the association which exists among data in each position on the source code, based on the source code and the data information; process extracting means for extracting each piece of association information on each process in the source code as process information which is the information indicating the process, based on the source code, the data information, and the association information.

In addition, Japanese Patent Application Laid-Open Publication No. 2013-45307 describes a static analysis system including: a static analysis device including a verification executing unit for statically analyzing all source code files regardless of whether to change or not, a repository for storing the source code file and verification results from the verification executing unit for each revision, and a confirmation-flag updating unit for updating a confirmation flag indicating whether to display each pointed item on a screen of a client device in the verification result or not; and a client device including a verification-result access unit for acquiring the verification result from the static analysis device, and a verification-result confirming unit for displaying a list of the pointed items of the verification result and displaying a screen on which a pointed item not required to be displayed in a next static analysis is selected by a user and for transmitting the verification result containing the pointed item not required to be displayed to the confirmation-flag updating unit.

Meanwhile, in the software development in recent years, a technique which is called social coding has been popularized, the social coding making development by, for example, sharing the source code, etc. on the repository located on a cloud computing environment, etc., and making a plurality of developers cooperate with each other via a network. A process of review, etc. is executed via the network in some cases. Note that, for example, GitHub homepage, [searched on Jun. 20, 2014], Internet <URL: https://github.com> is known as a tool and a system for performing the social coding.

### SUMMARY

The static test in the social coding is executed remotely via the network in some cases. Therefore, for example, in the source code review, it is unclear whether a reviewer actually visually has checked all the target source codes or not because there is no evidence for the check, and therefore, it is judged whether the review has been executed or not based on self-reporting. Therefore, there is a problem of no guarantee for a quality of the review.

In addition, generally, the source code is hardly created from the beginning, and the source code is created often by entirely or partially citing a source code from another program having actual performance from the viewpoint of efficiency and improvement in the quality. However, when the static test is executed to such a source code in a systematic procedure, a part cited from the source code of the program which has been already reviewed and which also has actual performance is reviewed again as similar to the part which has created from zero, resulting in inefficiency due to double review.

Accordingly, an object of the present invention is to provide a static test supporting system which can record at least an evidence of the actual visual check for the target source code by the reviewer in the static test for the source code review, etc. in the social coding, and can accumulate and display information indicating who has actually checked the source code and when the check has been executed as a result of executing the static test.

The above and other objects and novel characteristics of the present invention will be apparent from the description of the present specification and the accompanying drawings.

The typical summary of the inventions disclosed in the present application will be briefly described as follows.

The static test supporting system according to typical embodiments of the present invention is a static test supporting system for supporting a static test in social coding, the system having a configuration in which a network is connected with each of a development managing server having a social coding system, one or more developer terminal(s) which is an information processing terminal(s) owned by a developer(s) and which has a client function of the social coding system, and one or more reviewer terminal(s) which is an information processing terminal(s) owned by a reviewer(s) and which has a client function of the social coding system.

The development managing server has a review control unit for recording the execution information of the static test acquired from the reviewer terminal on a review-status recording unit, and the reviewer terminal has a reviewer viewpoint monitoring unit for acquiring information on the viewpoint of the reviewer with an eye camera. When the reviewer executes a static test for the source code displayed on the reviewer terminal, the information on the viewpoint acquired by the reviewer viewpoint monitoring unit is tracked, it is regarded that a row corresponding to a route of the viewpoint in the source code has been visually checked by the reviewer, and regarded that the check for the row has been executed when the reviewer has visually checked a certain proportion of the row or higher, and execution information on the static test containing the date of the check, the checked row, and the information on the reviewer is transmitted to the development managing server.

The effects obtained by typical aspects of the present invention disclosed in the present application will be briefly described below.

That is, according to a typical embodiment of the present invention, in the static test for the source code review, etc. in the social coding, evidence for at least the actual visual check of the target source code by the reviewer can be recorded, and information indicating who has actually checked the source code and when the check has been executed can be accumulated and displayed as a result of executing the static test.

### BRIEF DESCRIPTIONS OF THE DRAWINGS

FIG. 1 is a diagram showing an outline of an example of a configuration of a static test supporting system according to one embodiment of the present invention;

FIG. 2 is a diagram showing an outline of an example of data configuration of a review status DB according to one embodiment of the present invention;

FIG. 3 is a diagram showing an outline of an example of a screen viewed when a reviewer performs source code review on a reviewer terminal according to one embodiment of the present invention;

FIG. 4 is a diagram showing an outline of another example of the screen viewed when the reviewer performs source code review on the reviewer terminal according to one embodiment of the present invention; and

FIG. 5 is a diagram showing an outline of an example of a screen viewed when a developer terminal and a reviewer terminal cooperate with each other for the source code review, according to one embodiment of the present invention.

### DETAILED DESCRIPTION

Hereinafter, embodiments of the present invention will be described in detail with reference to the accompanying drawings. Note that the same components are denoted by the same reference symbols throughout all the drawings for describing the embodiments, and the repetitive description thereof will be omitted.

In a static test supporting system according to one embodiment of the present invention, a viewpoint or a line of sight of a reviewer is detected by using an eye camera (viewpoint sensor) provided in a client terminal of the reviewer in the static test of the source code review, etc. in the social coding, and, for example, when the viewpoint passes through all the codes in a row for each row of the source code, it is regarded that the check of the row is completed. In this manner, the evidence of the actual visual check on the part of the source code by the reviewer is acquired, so that coverage is ensured.

Also, information indicating by whom (which reviewer), when, and in what order each row of the source code has been actually checked is accumulated, and besides, the information is associated with each row of the source code, and is displayed on the client terminals of the developer and the reviewer. In this manner, for example, the developer who has requested the review can recognize the information indicating by whom, how long in staying time, and which of the rows has been visually reviewed and in what order the rows of the source code are tracked, so that the quality of the review can be improved, and the efficiency thereof can be achieved.

That is, the developer can trace the logic actually tacked by the reviewer, so that the developer can recognize which part has been intensively checked, and therefore, the developer can acquire useful reference information which leads to the quality improvement of the source code. Moreover, when the reviewer is a highly skilled and well-known person, the reviewing by such reviewer motivates the developer, so that the further improvement of the quality and the developer's skill can be expected. In addition, the source code checked by such reviewer is assumed to be highly reliable and of high quality, and therefore, efficiency such as eliminating the static test can be achieved.

In addition, when the source code is created by citing the source code of the program already having the actual performance, etc., the creation by the citation is clearly specified on the corresponding part of the source code, and is displayed on the client terminals of the developer and the reviewer. Such a part is also assumed to be highly reliable and of high quality, and therefore, the efficiency such as eliminating the static test, etc. can be achieved.

### System Configuration

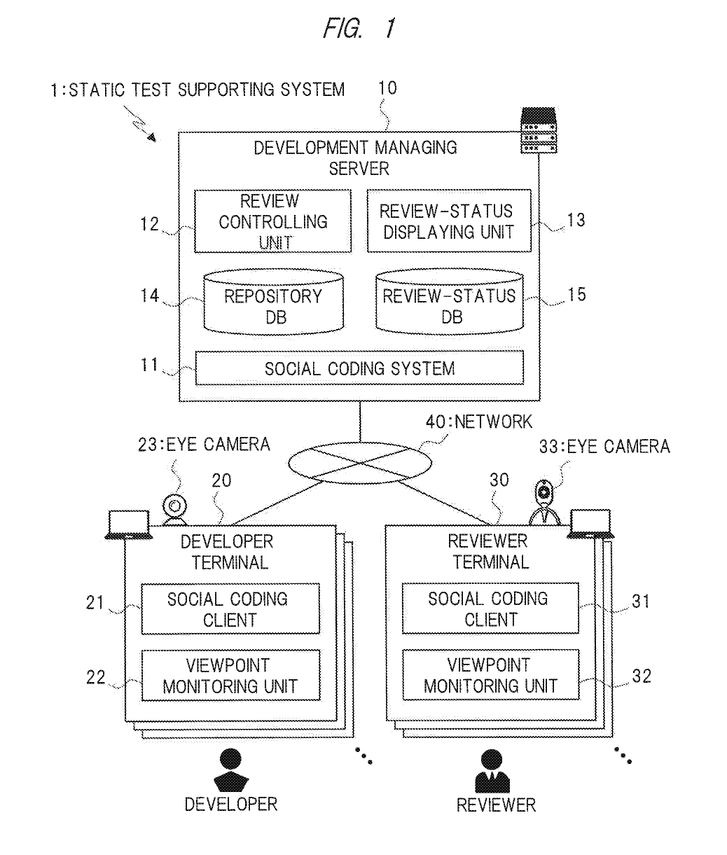

FIG. 1 is a diagram showing an outline of an example of a configuration of the static test supporting system according to one embodiment of the present invention. A static test supporting system 1 has a configuration in which a developer terminal 20 which is an information processing terminal used by each of a plurality of developers and a reviewer terminal 30 which is an information processing terminal used by each of a plurality of reviewers are connected to a development managing server 10 via a network 40 such as the Internet and intranet so as to be communicable with each other.

The development managing server 10 is implemented by, for example, a server device or a virtual server, etc. built on cloud computing environment, and is a server system for providing functions to manage and support development of the source code, etc. developed by a plurality of developers via the network 40. The development managing server 10 includes: units such as OS (Operating System) and DBMS (DataBase Management System) which are not shown, a social coding system 11 implemented by a software which operates on a middleware such as a Web server program, a review controlling unit 12, a review-status displaying unit 13, and others. In addition, it also includes tables such as a repository database (DB) 14 implemented by a database, etc., and a review status DB 15.

The social coding system 11 is a server system or a tool for providing a function of the social coding, and, for example, a publicly-known tool such as GitHub described above can be appropriately used for the system. In the social coding system 11, a version is managed by storing, for example, developed products such as the developed source code and program in a repository DB 14. In addition, when development is newly made, development management such as development (coding) of the source code, test, review, reflection to an original branch, registration, etc. for a unit of a branch is executed by creating the branch as a unit for development derived and branched from a master source code or a base source code and by registering the branch in the repository DB 14.

The review controlling unit 12 has a function to cooperate with social coding system 11 and to support and control operation of the review (static test) by the reviewer on the developed source code, etc. Here, for example, it has a function to acquire review execution information from reviewer terminal 30, etc., indicating which of the rows in the source code and when each reviewer has actually visually checked in order to guarantee whether or not the reviewer has actually visually checked a required part in the source code in the review, and to record and accumulate the information in review status DB 15 as a history.

The review-status displaying unit 13 has a function to cooperate with social coding system 11 to display together a review status of the target source code when the social coding system 11 displays the source code, etc. under the development on the developer terminal 20 and the reviewer terminal 30. For example, it has a function to extract information indicating when, by which reviewer, and in what order each row in the target source code has been actually visually checked based on the history information on the review operation accumulated in review status DB 15, and to display the information on a screen described later.

The developer terminal 20 and the reviewer terminal 30 are client systems each of which is implemented by an information processing terminal such as PC (personal computer), and which provides a function including a user interface used when the developer and the reviewer access the development managing server 10 via the network 40 and actually perform works of the development, the test, and the review of the source code, etc. The developer terminal 20 and the reviewer terminal 30 include, for example, social coding clients 21 and 31, viewpoint monitoring units 22 and 32, etc. each of which is implemented by a middleware such as OS or a software which operates on a web browser not shown, respectively.

Each of the social coding clients 21 and 31 is a client application corresponding to the social coding system 11 of the development managing server 10, and has a function to provide an interface used when a user performs works of the development, the test, and the review of the source code, etc.

The viewpoint monitoring units 22 and 32 have functions to always track positions of the viewpoints of the developer and the reviewer who use the developer terminal 20 and the reviewer terminal 30, respectively. Publicly-known eye tracking technique, tool, etc. can be appropriately used, for example, they controlling eye cameras 23 and 33 provided the developer terminal 20 and the reviewer terminal 30, respectively, acquiring information of eye movement, etc. of the developer and the reviewer, and calculating and outputting the viewpoints based on the information. Note that each of the eye cameras 23 and 33 is configured by, for example, a camera taking a picture of movement of an eyeball, an infrared sensor detecting a position of an iris of the eye, etc.

By the viewpoint monitoring units 22 and 32, it can be recognized which part of which row in the source code the developer and the reviewer are actually viewing in a state in which, for example, the source code is displayed on the screens of the developer terminal 20 and the reviewer terminal 30 by the social coding clients 21 and 31 for the review. When it is judged that the reviewer has visually checked each row, information indicating the judgment is transmitted to the review controlling unit 12 of the development managing server 10, and the information is recorded in the review status DB 15 by the review controlling unit 12 as a history.

In the example of FIG. 1, note that the developer terminal 20 also has the viewpoint monitoring unit 22 and the eye camera 23 so that the developer's viewpoint can be tracked. However, it is not always required to provide them for the developer terminal 20. The reviewer terminal 30 at least has the viewpoint monitoring unit 32 and the eye camera 33, and it is only required to track the viewpoint of the reviewer in the review.

### Data Configuration

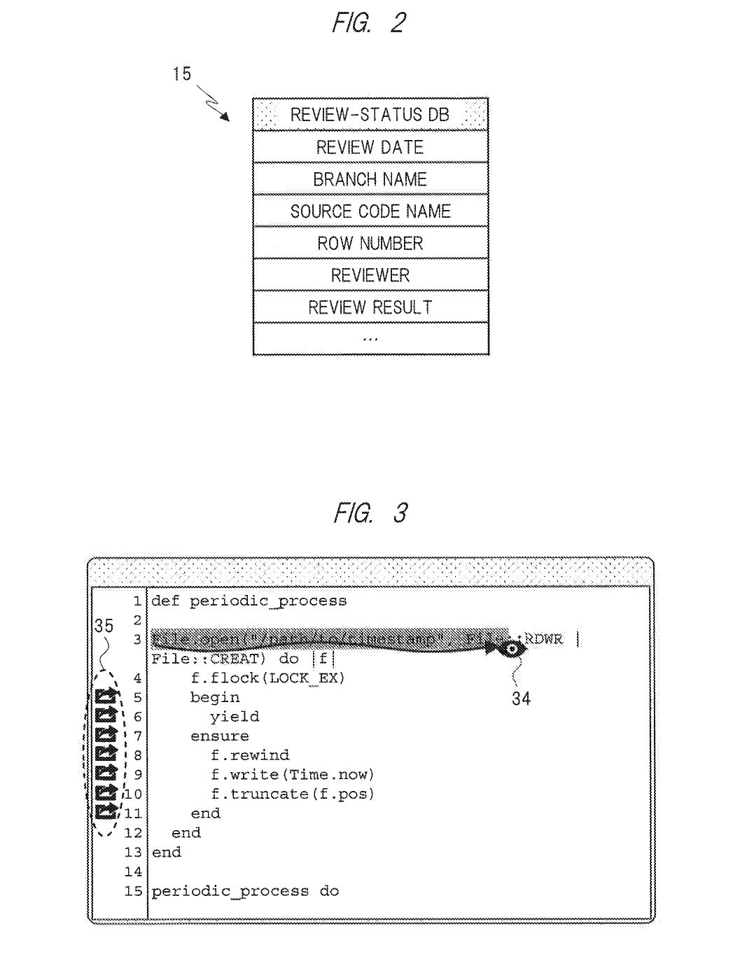

FIG. 2 is a diagram showing an outline of an example of a data configuration of the review status DB 15 of the development managing server 10. The review status DB 15 is a table for maintaining the execution information and the information on the status of the static test for the source code review of each source code under the development in a unit of the source code, and contains, for example, each item of review date, a branch name, a source code name, a row number, a reviewer, a review result, and others.

The item of the review date maintains a time stamp information at a moment when the review of the target has been executed, that is, when the reviewer has visually checked the target row in the source code. The item of the branch name maintains information of a name, etc. for specifying the branch containing the target source code. The item of the source code name maintains information, including the name, etc. for specifying the target source code. The item of the row number maintains information on a row number for specifying the row which the reviewer has visually checked in the target source code. The item of the reviewer maintains information on an ID, a name, etc., for specifying the reviewer who has visually reviewed the target row in the target source code. The item of the review result maintains information on a result (for example, OK/NG) of the review for the target row in the target source code.

Note that each data configuration (item) of the table shown in FIG. 2 is only an example, and other table configuration and data configuration may also be used as long as the similar data can be maintained/managed.

### Processing Image

FIG. 3 is a diagram showing an outline of an example of a screen displayed when the reviewer performs the source code review on the reviewer terminal 30. The source code is displayed together with the row number on the screen by the social coding client 31, and the viewpoint pointer 34 is displayed in the third row of the source code by the viewpoint monitoring unit 32 of reviewer terminal 30. The viewpoint pointer 34 shows a current position of the viewpoint of the reviewer acquired by the eye camera 33 and the viewpoint monitoring unit 32, and moves on the screen as following the movement of the viewpoint actually moved by the reviewer. A curved arrow going toward the viewpoint pointer 34 in the drawing schematically shows a route of the movement of the viewpoint pointer 34 (not actually displayed on the screen).

In the example of FIG. 3, from the route of the viewpoint, it is judged that the third row of the source code has been visually checked. The viewed part, i.e., the corresponding part of each row on the route of the viewpoint can be identified by, for example, changing such a method of displaying a character as changing or reversing a background color as shown in the drawing by cooperation of the social coding client 31 and the viewpoint monitoring unit 32. When it is detected that the reviewer has visually viewed the entire row of each row or a predetermined proportion or more of the entire row (for example, 90 percent), it is judged that the target row has been visually reviewed, and the data of the date, the row number, etc. is transmitted to the development managing server 10 and is recorded on the review status DB 15. At this time, if there is no correction, comment, or others on the target row, the review result may be determined to be “OK”.

As described above, generally, the source code is hardly created from the beginning, and is created often by citing entirely or partially a source code of other program having actual performance from the viewpoint of the efficiency and the quality improvement. Such a cited part is assumed to be highly reliable and of high quality, and therefore, the efficiency such as eliminating the static test of the source code review, etc., can be achieved.

In this embodiment, as shown in FIG. 3, for example, a citation mark 35 is additionally displayed on a left side of the row number of the row cited from another source code so that the citation can be recognized. The identification information such as a creator of the source code of the cited source may be displayed by selecting the citation mark 35 by the user with the mouse click, etc. Moreover, information on the number of the citation of the source code of the cited source cited from another source code, and on the number of times of the executed review, etc. may be displayed together. These pieces of information can become an index to relatively improve reliability of a source code of the cited source and a source code which cites the source code.

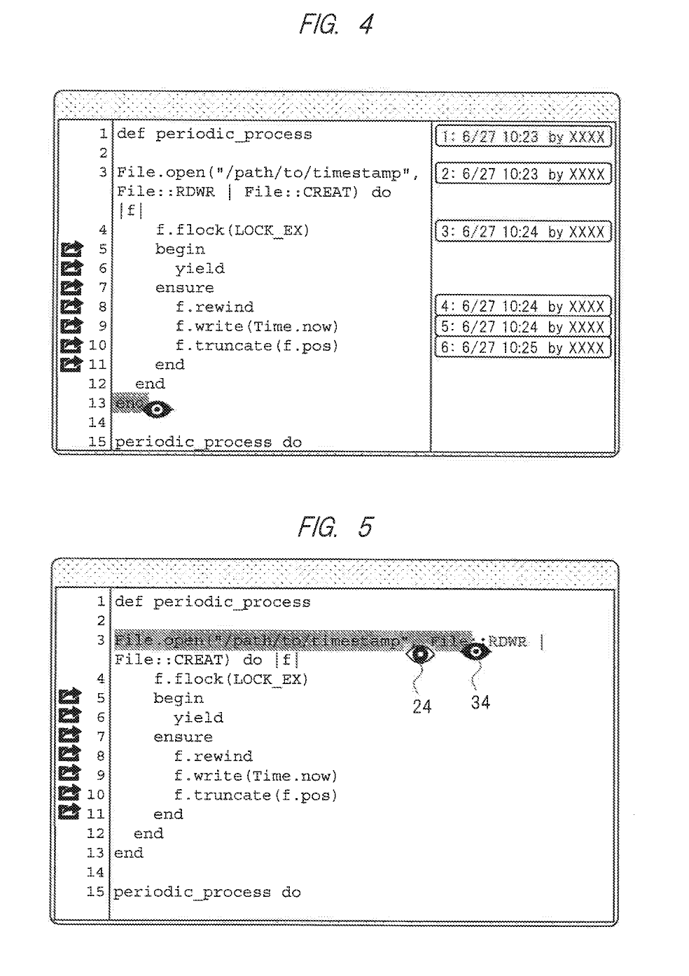

FIG. 4 is a diagram showing an outline of another example of the screen displayed when the reviewer performs the source code review on the reviewer terminal 30. Here, in addition to the example of the screen shown in FIG. 3, for example, a review order of the respective rows, a time stamp of the executed review, and information to specify the reviewer, are displayed on a right side of each row as the information related to the executed review when the reviewer has actually visually reviewed the corresponding row. These pieces of information can also be displayed when the corresponding source code is displayed on the developer terminal 20. In the example of FIG. 4, the review operation information by the specific reviewer is displayed. However, the displayed content is not limited to this. For example, the information on the review result (OK/NG) may be displayed so as to be identifiable with a symbol, a character string, a color, etc., or execution information for each reviewer and information on the review result may be displayed when the review has been executed by a plurality of reviewers.

FIG. 5 is a diagram showing an outline of an example of a screen displayed when the developer terminal 20 and the reviewer terminal 30 cooperate with each other to execute the source code review. Here, in each of the developer terminal 20 and the reviewer terminal 30, in addition to the viewpoint pointer 34 of the reviewer in the example of the screen shown in FIG. 3, a viewpoint pointer 24 showing a current position of the viewpoint of the developer is displayed at the same time. The developer's viewpoint pointer 24 shows a current position of the viewpoint of the developer acquired by the eye camera 23 and the viewpoint monitoring unit 22 in the developer terminal 20, and moves on the screen as following the movement of the viewpoint actually moved by the developer.

In the example of FIG. 5, the developer terminal 20 and the reviewer terminal 30 transmit and receive the position information of the viewpoint to/from each other via the network 40 and the review controlling unit 12 of the development managing server 10, so that the viewpoint pointer on the other side in addition to its own viewpoint pointer can be displayed at the same time. In this manner, for example, even when the developer and the reviewer are located in distant places from each other, each person (side) can execute efficiently the static test of the source code review, etc., while recognizing which part on the source code the other side actually viewing.

As described above, in the static test supporting system according to one embodiment of the present invention, the viewpoint of the reviewer is detected by the eye camera 33 provided in the reviewer terminal 30 in the static test of the source code review, etc., and, when the viewpoint has passed through all the codes in the row for each row of the source code, it is regarded that the check for the corresponding row is completed. In this manner, the evidence of the actual visual check for the corresponding part of the source code by the reviewer is acquired, so that the coverage is ensured. In addition, the viewpoint of the developer is similarly detected by providing the eye camera 23 also in the developer terminal 20, and this information is displayed on the screen together with the information on the viewpoint of the reviewer, so that the developer and the reviewer can share information on the viewpoints, and they can execute the review in cooperation with each other even in the distant places.

Also, the review execution information indicating by which reviewer, when, and in what order, each row of the source code has been actually checked is accumulated, and besides, the information is displayed on the client terminals of the developer and the reviewer so as to correspond each row of the source code. In this manner, for example, the developer who has requested the review can recognize the information indicating by which reviewer, how long in the staying time, and which row has been visually reviewed, and indicating in what order each row of the source code has been tracked, so that the quality of the development and the review can be improved, and the efficiency thereof can be achieved.

In addition, the creation of the source code by the citation of another source code is displayed on the client terminals of the developer and the reviewer while being clearly specified on the corresponding part, so that the part which is assumed to be highly reliable and of high quality can be recognized, the efficiency such as eliminating the static test or others can be achieved.

In the foregoing, the invention made by the present inventor has been concretely described based on the embodiments. However, it is needless to say that the present invention is not limited to the foregoing embodiments and various modifications and alterations can be made within the scope of the present invention. For example, the above-described embodiments have been described in order to understandably describe the present invention in detail, and are not always limited to the one including all the described configurations. Also, other configuration can be added to/eliminated from/replaced with a part of the configurations of the above-described embodiments.

The present invention can be utilized for a static test supporting system for supporting execution of the static test of source code review, etc.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A static test supporting system for supporting a static test in social coding,
wherein a network is connected with each of
a development managing server which has a social coding system,
one or more developer terminals each of which is an information processing terminal owned by a developer and has a client function of the social coding system, and
one or more reviewer terminals each of which is an information processing terminal owned by a reviewer and has a client function of the social coding system,
the development managing server has a review controlling unit for recording execution information of the static test acquired from the reviewer terminal on a review-status recording unit, and
the reviewer terminal has a reviewer viewpoint monitoring unit for acquiring information on a viewpoint of the reviewer by using an eye camera, and, when the reviewer executes the static test for the source code displayed on the reviewer terminal, the information on the viewpoint acquired by the reviewer viewpoint monitoring unit is tracked, it is regarded that the reviewer has visually checked a row corresponding to a route of the viewpoint in the source code and regarded that the check for the row has been executed when a predetermined proportion of the row or higher has been visually checked, and execution information on the static test containing date of the check, the checked row, and information related to the reviewer is transmitted to the development managing server.

2. The static test supporting system according to claim 1,
wherein the development managing server further has
a review-status displaying unit for displaying the execution information on the static test for the row recorded on the review-status recording unit and information on an order in which the check by the reviewer has been executed for each row of the source code when the source code is displayed on the developer terminal or the reviewer terminal.

3. The static test supporting system according to claim 1,
wherein, when the source code is displayed on the developer terminal or the reviewer terminal, if the row in the source code has been cited from another source code, the development managing server displays one or more pieces of information indicating the citation and a developer of the another source code, information on the number of the citation of the another source code from still another source code, and information on the number of times of the execution of the static test for the other source code.

4. The static test supporting system according to claim 1,
wherein the developer terminal has a developer viewpoint monitoring unit for acquiring information on the viewpoint of the developer by using an eye camera, and,
when the reviewer executes the static test for the source code, the development managing server displays the source code on the developer terminal and the reviewer terminal, and displays information on the viewpoint of the reviewer acquired by the reviewer viewpoint monitoring unit of the reviewer terminal and information on the viewpoint of the developer acquired by the developer viewpoint monitoring unit of the developer terminal on the respective terminals.
